(19) United States
(12) Patent Application Publication
(10) Pub. No.: US 2020/0073176 A1
(43) Pub. Date: Mar. 5, 2020

(54) LIQUID CRYSTAL DISPLAY DEVICE

(71) Applicant: Sharp Kabushiki Kaisha, Sakai City (JP)

(72) Inventor: Shinichi MIYAZAKI, Sakai City (JP)

(21) Appl. No.: 16/548,884

(22) Filed: Aug. 23, 2019

Related U.S. Application Data
(60) Provisional application No. 62/725,294, filed on Aug. 31, 2018.

(51) Int. Cl. G02F 1/1335; F21V 8/00

(52) U.S. Cl. CPC G02F 1/133611; G02B 6/005; G02F 1/133606

(57) ABSTRACT

The present invention provides a liquid crystal display device in which light leakage in a curved state is reduced or eliminated. The liquid crystal display device includes: a liquid crystal panel including a curved screen; and a backlight including a light source, the screen of the liquid crystal panel including a first screen region and a second screen region having a lower light transmittance than the first screen region, the backlight including a light-emitting region including a first light-emitting region corresponding to the first screen region and a second light-emitting region corresponding to the second screen region, the first light-emitting region having a lower luminance than the second light-emitting region.

### CROSS-REFERENCE TO RELATED APPLICATIONS

The present application claims priority under 35 U.S.C. § 119 to U.S. Provisional Patent Application No. 62/725,294 filed on Aug. 31, 2018, the contents of which are incorporated herein by reference in their entirety.

### BACKGROUND OF THE INVENTION

### Field of the Invention

The present invention relates to liquid crystal display devices.

### Description of Related Art

Liquid crystal display devices are display devices utilizing a liquid crystal layer (liquid crystal molecules) to display images (e.g., JP 2011-203588 A and JP 2017-161772 A). A typical display mode for liquid crystal display devices applies light from a backlight to a liquid crystal layer held between a pair of substrates and controls the amount of light transmitted through the liquid crystal layer by applying voltage to the liquid crystal layer to change the alignment of liquid crystal molecules.

### BRIEF SUMMARY OF THE INVENTION

Along with use of liquid crystal display devices in various applications, techniques to curve the liquid crystal display devices have been studied. Curving a liquid crystal display device, however, generates stress in the pair of substrates constituting the liquid crystal display device, resulting in a photoelastic retardation. This may cause light leakage in the screen. The light leakage is perceived as, for example, a pale white display portion on a black display screen.

As described above, there has been an issue of reducing or eliminating light leakage when a liquid crystal display device is curved, and the inventions disclosed in JP 2011-203588 A and JP 2017-161772 A, for example, can still be improved in terms of this issue of reducing or eliminating light leakage.

In response to the above issue, an object of the present invention is to provide a liquid crystal display device in which light leakage in a curved state is reduced or eliminated.

(1) One embodiment of the present invention is directed to a liquid crystal display device including: a liquid crystal panel including a curved screen; and a backlight including a light source, the screen of the liquid crystal panel including a first screen region and a second screen region having a lower light transmittance than the first screen region, the backlight including a light-emitting region including a first light-emitting region corresponding to the first screen region and a second light-emitting region corresponding to the second screen region, the first light-emitting region having a lower luminance than the second light-emitting region.

(2) In an embodiment of the present invention, the liquid crystal display device includes the above structure (1), the first screen region includes corners of the screen of the liquid crystal panel, and the second screen region is a region other than the corners.

(3) In an embodiment of the present invention, the liquid crystal display device includes the structure (1) or (2), the backlight further includes a light guide plate, the light source is disposed to face a side surface of the light guide plate, and the light guide plate has a lower light extraction efficiency in its region corresponding to the first light-emitting region than in its region corresponding to the second light-emitting region.

(4) In an embodiment of the present invention, the liquid crystal display device includes the structure (1) or (2), the backlight further includes a light diffuser plate disposed closer to the liquid crystal panel than the light source is, and the light diffuser plate has a lower light extraction efficiency in its region corresponding to the first light-emitting region than in its region corresponding to the second light-emitting region.

(5) In an embodiment of the present invention, the liquid crystal display device includes any one of the structures (1) to (4), the backlight further includes a light transmittance adjustment film disposed closer to the liquid crystal panel than the light source is, and the light transmittance adjustment film has a lower light transmittance in its region corresponding to the first light-emitting region than in its region corresponding to the second light-emitting region.

(6) In an embodiment of the present invention, the liquid crystal display device includes any one of the structures (1) to (5), the light-emitting region includes blocks including a block in the first light-emitting region and a block in the second light-emitting region, and a luminance of the backlight is adjustable for each of the blocks.

The present invention can provide a liquid crystal display device in which light leakage in a curved state is reduced or eliminated.

### BRIEF DESCRIPTION OF THE DRAWINGS

FIG. 1 is a schematic perspective view showing a liquid crystal display device of Embodiment 1 in a non-curved state.

FIG. 2 is a schematic cross-sectional view of the portion taken along the line A1-A2 in FIG. 1.

FIG. 3 is a schematic perspective view showing the liquid crystal display device in FIG. 1 in a curved state.

FIG. 4 is a schematic cross-sectional view of the portion taken along the line A1-A2 in FIG. 3.

FIG. 5 is a photograph showing exemplary light leakage in the black display screen generated in a conventional liquid crystal display device in a curved state.

FIG. 6 shows a simulation result of the compressive stress direction in a second substrate at the corner surrounded by the dotted line in FIG. 5.

FIG. 7 shows a simulation result of the intensity of light leakage near the corner surrounded by the dotted line in FIG. 5.

FIG. 8 is a schematic perspective view of a liquid crystal display device of Embodiment 2.

FIG. 9 is a schematic cross-sectional view of the portion taken along the line B1-B2 in FIG. 8.

FIG. 10 is a schematic perspective view of a liquid crystal display device of Embodiment 3.

FIG. 11 is a schematic cross-sectional view of the portion taken along the line C1-C2 in FIG. 10.

FIG. 12 is a graph showing the effect of reducing or eliminating light leakage in the liquid crystal display device of the present invention in a curved state.

### DETAILED DESCRIPTION OF THE INVENTION

The present invention is described in more detail based on the following embodiments with reference to the drawings. The embodiments, however, are not intended to limit the scope of the present invention. The configurations of the embodiments may appropriately be combined or modified within the spirit of the present invention.

Herein, “X to Y” means “X or more and Y or less”.

### Embodiment 1

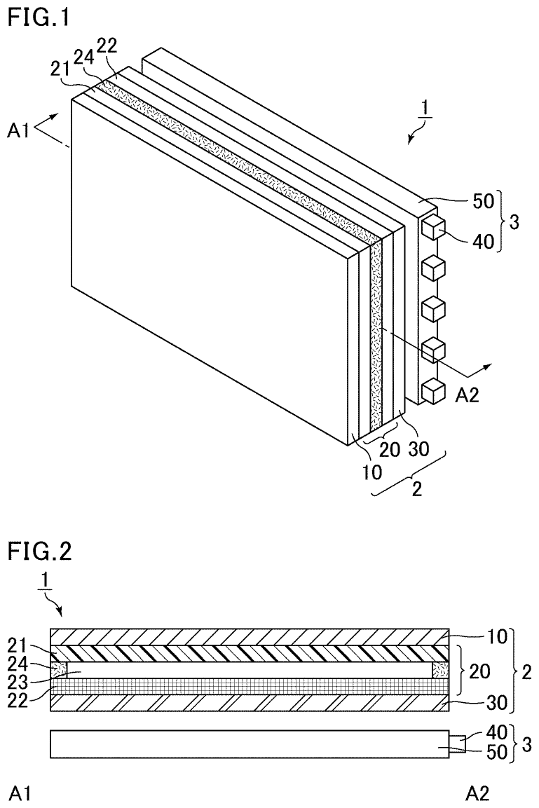

FIG. 1 is a schematic perspective view showing a liquid crystal display device of Embodiment 1 in a non-curved state. FIG. 2 is a schematic cross-sectional view of the portion taken along the line A1-A2 in FIG. 1. As shown in FIGS. 1 and 2, a liquid crystal display device 1 includes a liquid crystal panel 2 and a backlight 3 sequentially from the viewing surface side to the back surface side.

The viewing surface side herein means the side closer to the screen of the liquid crystal display device (liquid crystal panel), which is, for example, the liquid crystal panel 2 side of the liquid crystal display device 1 in FIG. 1. The back surface side herein means the side farther from the screen of the liquid crystal display device (liquid crystal panel), which is, for example, the backlight 3 side of the liquid crystal display device 1 in FIG. 1.

The liquid crystal panel 2 includes a first polarizing plate 10, a liquid crystal cell 20, and a second polarizing plate 30 sequentially from the viewing surface side to the back surface side.

The liquid crystal cell 20 includes a first substrate 21, a second substrate 22, a liquid crystal layer 23, and a sealant 24. In the liquid crystal cell 20, the first substrate 21 is disposed on the first polarizing plate 10 side, and the second substrate 22 is disposed on the second polarizing plate 30 side and faces the first substrate 21. The liquid crystal layer 23 is held between the first substrate 21 and the second substrate 22. The sealant 24 surrounds the liquid crystal layer 23 and bonds the outer edges (four sides) of the first substrate 21 and the second substrate 22.

The first substrate 21 may be, for example, a transparent substrate such as a glass substrate or a plastic substrate. On the liquid crystal layer 23 side of the first substrate 21 may appropriately be disposed component(s) such as color filters, a black matrix, and/or an overcoat layer. These components can be known ones.

The second substrate 22 may be, for example, a transparent substrate such as a glass substrate or a plastic substrate. On the liquid crystal layer 23 side of the second substrate 22 may appropriately be disposed component(s) such as gate lines, source lines, thin-film transistor elements, and/or electrodes. These components can be known ones.

The liquid crystal layer 23 contains a liquid crystal material, which may be a positive liquid crystal material having positive anisotropy of dielectric constant or a negative liquid crystal material having negative anisotropy of dielectric constant.

The sealant 24 may be, for example, a cured product of a curable resin-based adhesive such as acrylic epoxy-based adhesive. The curable resin-based adhesive may be one curable by light (photo-curable one), one curable by heat (heat-curable one), or one curable by both light and heat (photo- and heat-curable one).

The liquid crystal panel 2 may be a liquid crystal panel in a normally black mode such as the in-plane switching (IPS) mode, the fringe field switching (FFS) mode, or the vertical alignment (VA) mode, or in a normally white mode such as the twisted nematic (TN) mode. Herein, a liquid crystal panel in a normally black mode has the minimum light transmittance (in the black display state) with no voltage applied to the liquid crystal layer and increases in light transmittance as the magnitude of voltage applied to the liquid crystal layer increases. A liquid crystal panel in a normally white mode has the maximum light transmittance (in the white display state) with no voltage applied to the liquid crystal layer and decreases in light transmittance as the magnitude of voltage applied to the liquid crystal layer increases.

The first polarizing plate 10 and the second polarizing plate 30 may each be, for example, obtained by dyeing a polyvinyl alcohol film with an iodine complex (or dye) to adsorb the iodine complex on the polyvinyl alcohol film, and stretching the film for alignment. The polarizing plate herein means a linearly polarizing plate (absorptive polarizing plate) and is distinguished from a circularly polarizing plate.

The transmission axes of the first polarizing plate 10 and the second polarizing plate 30 are preferably perpendicular to each other. In such a structure, the first polarizing plate 10 and the second polarizing plate 30 are in crossed Nicols. Thereby, for example, in the case where the liquid crystal panel 2 is in a normally black mode, the black display state is efficiently achieved with no voltage applied to the liquid crystal layer 23 and a grayscale display state (e.g., intermediate grayscale display state, white display state) is efficiently achieved with voltage applied to the liquid crystal layer 23. Herein, the state where the two axes are perpendicular to each other means that the axes form an angle of 87° to 93°, preferably 89° to 91°, more preferably 89.5° to 90.5°, particularly preferably 90° (perfectly perpendicular to each other). The transmission axis of the first polarizing plate 10 corresponds to the long direction in FIG. 1. The transmission axis of the second polarizing plate 30 corresponds to the short direction in FIG. 1.

The backlight 3 includes light sources 40 and a light guide plate 50. The light sources 40 face the side surface of the light guide plate 50. In the backlight 3, light emitted from the light sources 40 enters the light guide plate 50 from the side surface of the light guide plate 50, is repeatedly reflected on the surfaces, and is emitted from the surface close to the liquid crystal panel 2. The backlight 3 is what is called an edge-lit backlight.

The light sources 40 may be, for example, light emitting diodes (LEDs) or cold cathode fluorescent lamps (CCFLs).

The light guide plate 50 may be formed from, for example, a light-transmitting resin such as an acrylic resin or a polycarbonate-based resin.

The backlight 3 may sequentially include a prism sheet and a light diffuser sheet on the liquid crystal panel 2 side of the light guide plate 50 and a light reflective sheet on the other side of the light guide plate 50, which is remote from the liquid crystal panel 2.

As shown in FIGS. 1 and 2, in the state where the liquid crystal display device 1 is not curved and the liquid crystal panel 2 is in a normally black mode, for example, the liquid crystal panel 2, when irradiated with light from the backlight 3, is in the black display state with no voltage applied to the liquid crystal layer 23. Specifically, light emitted from the backlight 3 is transmitted through the second polarizing plate 30 and thereby converted into linearly polarized light vibrating in the direction parallel to the transmission axis of the second polarizing plate 30. The linearly polarized light from the second polarizing plate 30 is then transmitted sequentially through the second substrate 22, the liquid crystal layer 23, and the first substrate 21, and blocked (absorbed) by the first polarizing plate 10 whose transmission axis is perpendicular to the transmission axis of the second polarizing plate 30.

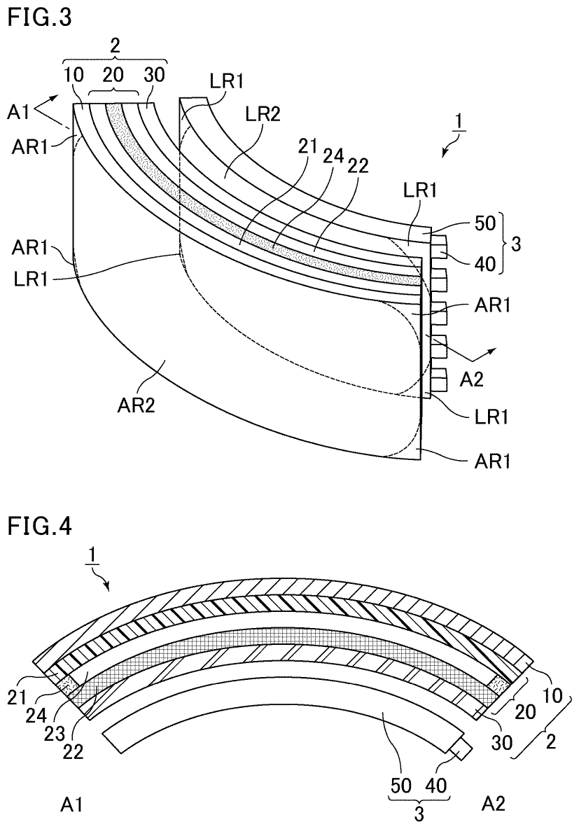

FIG. 3 is a schematic perspective view showing the liquid crystal display device in FIG. 1 in a curved state. FIG. 4 is a schematic cross-sectional view of the portion taken along the line A1-A2 in FIG. 3. As shown in FIGS. 3 and 4, in the state where the liquid crystal display device 1 is curved, the liquid crystal panel 2 has a curved screen and the backlight 3 is curved to fit the curved shape of the liquid crystal panel 2. Also in the state where the liquid crystal display device 1 is curved, tensile stress is generated in the first substrate 21 while compression stress is generated in the second substrate 22. This produces a photoelastic retardation in the first substrate 21 and the second substrate 22.

In the liquid crystal panel 2, the outer edges (four sides) of the first substrate 21 and the second substrate 22 are bonded to each other with the sealant 24. This structure, in the state where the liquid crystal display device 1 is curved, generates compressive stress in the second substrate 22 but causes the outer edges of the second substrate 22 to be pulled by the sealant 24. The compressive stress direction near the outer edges of the second substrate 22 therefore tends to shift significantly from the compressive stress direction in the other regions, which increases the retardation. Also, the tensile stress direction near the outer edges of the first substrate 21 tends to shift significantly from the tensile stress direction in the other regions, which increases the retardation.

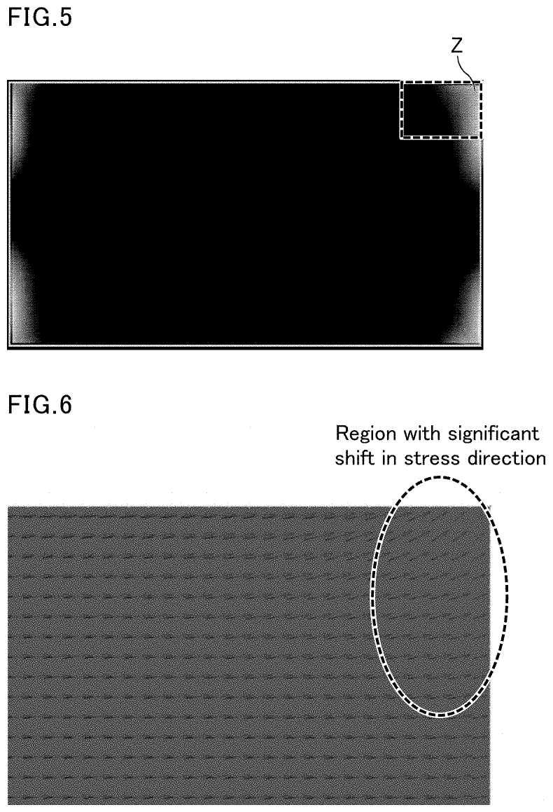

Accordingly, in the state where the liquid crystal display device 1 is curved, light leakage due to the retardation, such as light leakage Z at the corners (four corners) of the black display screen as shown in FIG. 5, was supposed to occur. FIG. 5 is a photograph showing exemplary light leakage in the black display screen generated in a conventional liquid crystal display device in a curved state. In FIG. 5, the long direction corresponds to the direction in which the transmission axis of the first polarizing plate 10 extends, and the short direction corresponds to the direction in which the transmission axis of the second polarizing plate 30 extends.

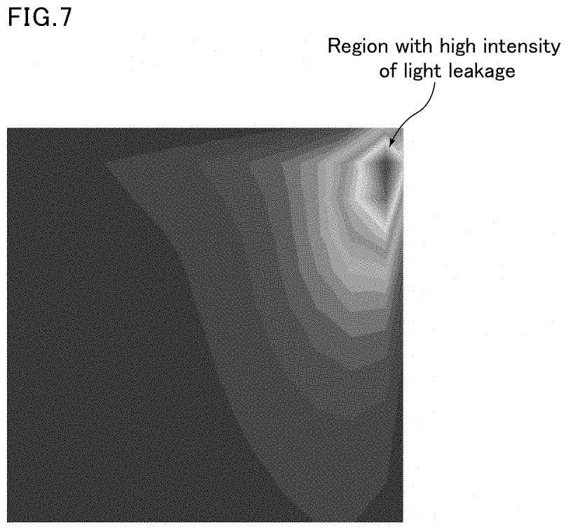

FIG. 6 shows a simulation result of the compressive stress direction in a second substrate at the corner surrounded by the dotted line in FIG. 5. In FIG. 6, the arrows indicate the compressive stress direction. FIG. 7 shows a simulation result of the intensity of light leakage near the corner surrounded by the dotted line in FIG. 5. In FIG. 7, the contour lines correspond to the intensity levels of light leakage. As shown in FIG. 6, in the state where the liquid crystal display device 1 is curved, the compressive stress direction in the second substrate 22 at the corner of the black display screen shifts significantly from the compressive stress direction in the other regions (the arrows point directions oblique from the long direction). Thus, in the state where the liquid crystal display device 1 is curved, the intensity of light leakage was supposed to be high at the corner of the black display screen and the intensity of light leakage was supposed to be low in the regions other than the corner of the black display screen as shown in FIG. 7.

The intensity of light leakage is known to have a proportional relationship represented by the following formula (F).

“Intensity of light leakage”∝[(C²t⁴E²)×sin²(2(β−α))]/R² (F)

α: azimuth angle of the transmission axis of the second polarizing plate 30 (first polarizing plate 10)

β: azimuth angle of the compressive stress (tensile stress) in the second substrate 22 (first substrate 21)

C: photoelastic constant of the second substrate 22 (first substrate 21)

t: thickness of the second substrate 22 (first substrate 21)

E: Young's modulus of the second substrate 22 (first substrate 21)

R: curvature radius of the second substrate 22 (first substrate 21)

According to the formula (F), the intensity of light leakage increases as β−α becomes close to 45°. Meanwhile, the intensity of light leakage is 0 when β−α is 0° or 90°. This is proved by the simulation results shown in FIGS. 6 and 7.

When the liquid crystal panel 2 is in a normally black mode, the intensity of light leakage is approximable by the above formula (F). In contrast, when the liquid crystal panel 2 is in a normally white mode, the intensity of light leakage is approximated by taking into account the retardation in the liquid crystal layer 23 as well as the retardation in the second substrate 22 (first substrate 21) (taken into account in the above formula (F)).

As described above, in the state where the liquid crystal display device 1 is curved, regions with a high intensity of light leakage and regions with a low intensity of light leakage were supposed to coexist in the screen of the liquid crystal panel 2. In other words, in the state where the liquid crystal display device 1 is curved, regions with a high light transmittance and regions with a low light transmittance were supposed to coexist in the screen of the liquid crystal panel 2.

In contrast, in Embodiment 1, the luminance distribution in the light-emitting region of the backlight 3 is adjusted so that light leakage is reduced or eliminated in the liquid crystal display device 1 in a curved state. For example, as shown in FIG. 3, in the state where the liquid crystal display device 1 is curved, the screen of the liquid crystal panel 2 includes first screen regions AR1, which are the corners of the screen, and a second screen region AR2, which is a region (at least the central portion of the screen) other than the corners and has a lower light transmittance than the first screen regions AR1. Also, the light-emitting region of the backlight 3 is divided into first light-emitting regions LR1 corresponding to (superimposed with) the first screen regions AR1 and a second light-emitting region LR2 corresponding to (superimposed with) the second screen region AR2, and the first light-emitting regions LR1 are adjusted to have a lower light transmittance than the second light-emitting region LR2. Thereby, in the liquid crystal display device 1 in a curved state, the amount of light emitted from the backlight 3 and transmitted through the first screen regions AR1, which are the corners of the screen of the liquid crystal panel 2, is small. This results in reduction or elimination of light leakage in the first screen regions AR1, whereby, for example, a pale white display portion observed at the corners of the black display screen in a conventional display device is less likely to be perceived. The luminance of the first light-emitting regions LR1 and the luminance of the second light-emitting region LR2 can be compared using the backlight 3 alone.

In order to adjust the luminances of the first light-emitting regions LR1 and the second light-emitting region LR2, in Embodiment 1, the light guide plate 50 has a lower light extraction efficiency (extraction efficiency of light emitted from the light sources 40) in its regions corresponding to the first light-emitting regions LR1 than in its region corresponding to the second light-emitting region LR2. The distribution of light extraction efficiency of the light guide plate 50 is adjustable by, for example, a method that controls a dot pattern density, a method using a turning lens, or a method that inserts a neutral density film between lens sheets. Herein, the light extraction efficiency means the ratio of emitted light to incident light when the light enters a component and is emitted through the component.

The range of each first light-emitting region LR1 may be set based on the simulation result shown in FIG. 6 with reference to the above formula (F). For example, the range in which the “intensity of light leakage” in the formula (F) is not zero, i.e., the range satisfying the formula “sin²(2(β−α))≠0” (the range in which light leakage occurs), may be selected from FIG. 6, and a region in the light-emitting region of the backlight 3 corresponding to the selected range may be treated as a first light-emitting region LR1.

The luminance of the first light-emitting regions LR1 may be set based on the simulation result shown in FIG. 7. For example, the luminance of the first light-emitting regions LR1 may be adjusted by dividing the luminance into a plurality of levels according to the distribution of the intensity levels of light leakage such that the intensity levels of light leakage shown in FIG. 7 are low and distributed uniformly.

Here, as described above, the intensity of light leakage is known to have a proportional relationship represented by the above formula (F), meaning that it is proportional to the fourth power of the thickness of the second substrate 22 (first substrate 21) and is inversely proportional to the square of the curvature radius of the second substrate 22 (first substrate 21). Thus, the thickness of the second substrate 22 (first substrate 21) is preferably small in order to reduce or eliminate light leakage, but the resulting liquid crystal display device 1 may have low handleability and poor production efficiency. Also, the curvature radius of the second substrate 22 (first substrate 21) is preferably large in order to reduce or eliminate light leakage, but the resulting liquid crystal display device 1 may exhibit limited designability. In contrast, in Embodiment 1, the luminance distribution in the light-emitting region of the backlight 3 is adjusted, so that light leakage can be reduced or eliminated without limiting the thickness and curvature radius of the second substrate 22 (first substrate 21).

### Embodiment 2

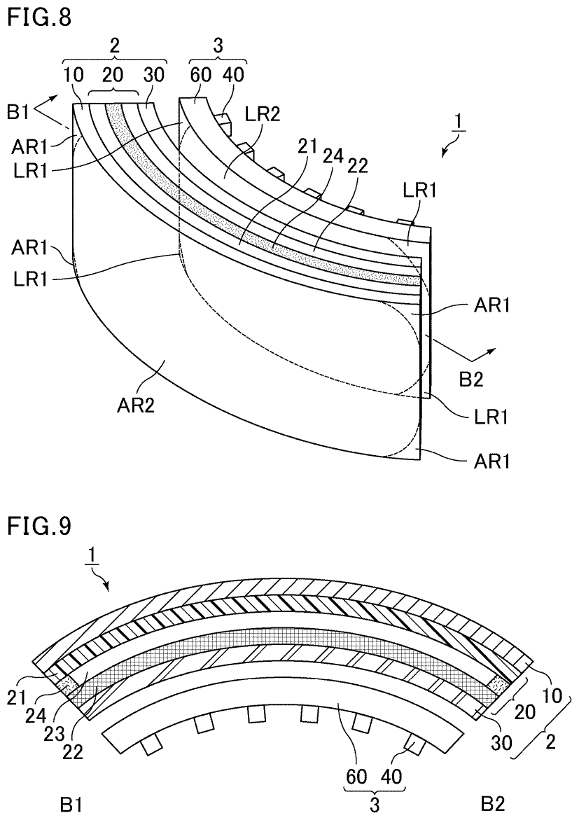

Embodiment 2 is the same as Embodiment 1 except for the structure of the backlight. Description of the same points is therefore not repeated here. FIG. 8 is a schematic perspective view of a liquid crystal display device of Embodiment 2. FIG. 9 is a schematic cross-sectional view of the portion taken along the line B1-B2 in FIG. 8.

The backlight 3 includes the light sources 40 and a light diffuser plate 60. The light diffuser plate 60 is disposed closer to the liquid crystal panel 2 than the light sources 40 are. In the backlight 3, light emitted from the light sources 40 is transmitted through the light diffuser plate 60 and emitted toward the liquid crystal panel 2 as diffused light. The backlight 3 is what is called a direct-lit backlight.

The light diffuser plate 60 may be, for example, one in which beads are kneaded into the substrate.

In order to adjust the luminances of the first light-emitting regions LR1 and the second light-emitting region LR2, in Embodiment 2, the light diffuser plate 60 has a lower light extraction efficiency (extraction efficiency of light emitted from the light sources 40) in its regions corresponding to the first light-emitting regions LR1 than in its region corresponding to the second light-emitting region LR2. The distribution of light extraction efficiency of the light diffuser plate 60 is adjustable by, for example, a method that inserts a neutral density film between lens sheets.

### Embodiment 3

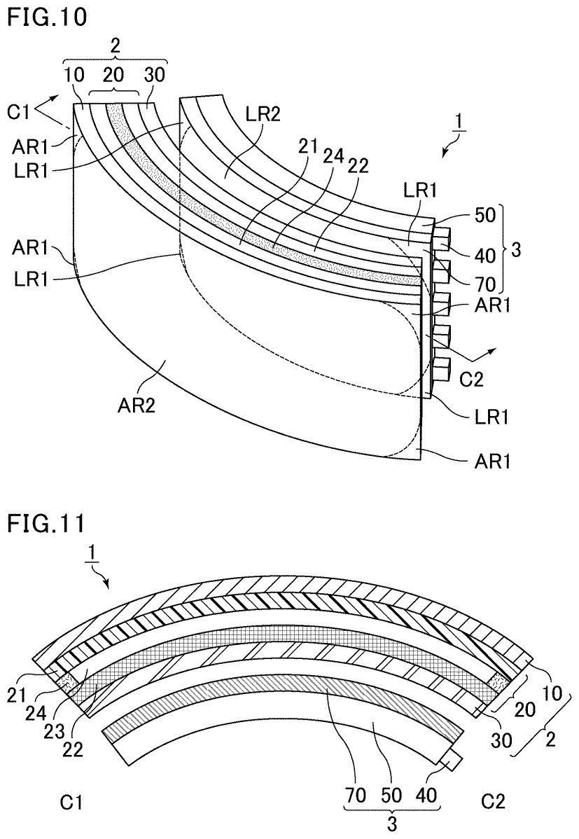

Embodiment 3 is the same as Embodiment 1 except for the structure of the backlight. Description of the same points is therefore not repeated here. FIG. 10 is a schematic perspective view of a liquid crystal display device of Embodiment 3. FIG. 11 is a schematic cross-sectional view of the portion taken along the line C1-C2 in FIG. 10.

The backlight 3 includes the light sources 40, the light guide plate 50, and a light transmittance adjustment film 70. The light transmittance adjustment film 70 is disposed closer to the liquid crystal panel 2 than the light sources 40 are.

In order to adjust the luminances of the first light-emitting regions LR1 and the second light-emitting region LR2, in Embodiment 3, the light transmittance adjustment film 70 has a lower light transmittance in its regions corresponding to the first light-emitting regions LR1 than in its region corresponding to the second light-emitting region LR2.

The light transmittance adjustment film 70 may be, for example, one in which a mesh pattern is printed on regions of the transparent film corresponding to the first light-emitting regions LR1 and thereby the distribution of the light transmittance is adjusted.

The distribution of light extraction efficiency of the light guide plate 50 may be adjusted as in Embodiment 1 or may not be adjusted (the distribution may or may not be uniform).

In Embodiment 3, the case is described where the light transmittance adjustment film 70 is used in an edge-lit backlight. Yet, the light transmittance adjustment film 70 may be used in a direct-lit backlight. In this case, the distribution of light extraction efficiency of the light diffuser plate in the direct-lit backlight may be adjusted as in Embodiment 2 or may not be adjusted (the distribution may or may not be uniform).

In Embodiments 1 to 3, the cases are described where the liquid crystal display device 1 is convexly curved toward the viewing surface. Yet, the liquid crystal display device 1 may be concavely curved toward the viewing surface. Also in Embodiments 1 to 3, the cases are described where the liquid crystal display device 1 is curved such that the ends in the long direction of the liquid crystal display device 1 come close to each other. Yet, the liquid crystal display device 1 may be curved such that the ends in the short direction come close to each other.

In Embodiments 1 to 3, the cases are described where light leakage was supposed to occur at the corners of the screen of the liquid crystal panel 2 in the liquid crystal display device 1 in a curved state. Yet, light leakage may occur at a position other than the corners of the screen of the liquid crystal panel 2 (e.g., a portion of the outer edges of the screen, the central portion of the screen) depending on the conditions such as the curved state of the liquid crystal panel 2 and the positional relationship between the transmission axes of the first polarizing plate 10 and the second polarizing plate 30. Even in such a case where light leakage is supposed to occur at a different position, light leakage can be reduced or eliminated as in Embodiments 1 to 3 by adjusting the luminance distribution in the light-emitting region of the backlight 3 according to the supposed position.

In modified examples of Embodiments 1 to 3, the backlight 3 may be what is called an active backlight (local dimming backlight) in which the light-emitting region includes blocks including a block in the first light-emitting regions LR1 and a block in the second light-emitting region LR2, and the luminance of the backlight 3 is adjustable for each of the blocks. For example, the light sources 40 may be disposed in M rows and N columns suited for the screen of the liquid crystal panel 2 and the light-emitting region of the backlight 3 may be divided into blocks in M rows and N columns, so that the luminance of each block may be adjusted. Here, one or more of the blocks in the light emitting region of the backlight 3 should be included in the first light-emitting regions LR1 and different one or more of the blocks should be included in the second light-emitting region LR2. Thereby, light leakage in the liquid crystal display device 1 in a curved state can be reduced or eliminated efficiently.

### [Evaluation]

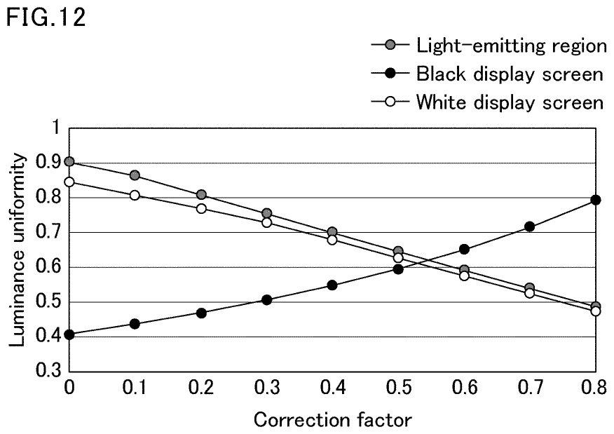

The luminance uniformities (distributions) of the black display screen and the white display screen were evaluated in the state where the liquid crystal display device of the present invention (thicknesses of the first substrate and the second substrate: 0.15 mm) was curved with a curvature radius of 800 mm and the luminance uniformity (distribution) of the light-emitting region of the backlight was adjusted. FIG. 12 is a graph showing the effect of reducing or eliminating light leakage in the liquid crystal display device of the present invention in a curved state. In FIG. 12, the “luminance uniformity” for the vertical axis is defined by “minimum luminance”/“maximum luminance”. In FIG. 12, the “correction factor” for the horizontal axis shows how much the luminance uniformity of the light-emitting region of the backlight was adjusted. For example, a correction factor of 100% corresponds to the case where the luminance uniformity of the light-emitting region of the backlight was adjusted such that the luminance at the position with light leakage (e.g., corner of the screen) was equal to the luminance at the position without light leakage (e.g., central portion of the screen). A correction factor of 0% corresponds to the case where the luminance uniformity of the light-emitting region of the backlight was not adjusted.

As shown in FIG. 12, adjustment of the luminance uniformity of the light-emitting region of the backlight enabled adjustment of the balance between the luminance uniformity of the black display screen and the luminance uniformity of the white display screen. In other words, the liquid crystal display device of the present invention reduced or eliminated light leakage in the black display screen, i.e., increased the luminance uniformity of the black display screen, while maintaining the luminance uniformity of the white display screen, by adjusting (reducing) the luminance uniformity of the light-emitting region of the backlight.

What is claimed is:

1. A liquid crystal display device comprising:
a liquid crystal panel including a curved screen; and
a backlight including a light source,
the screen of the liquid crystal panel including a first screen region and a second screen region having a lower light transmittance than the first screen region,
the backlight including a light-emitting region including a first light-emitting region corresponding to the first screen region and a second light-emitting region corresponding to the second screen region,
the first light-emitting region having a lower luminance than the second light-emitting region.

2. The liquid crystal display device according to claim 1,
wherein the first screen region includes corners of the screen of the liquid crystal panel, and
the second screen region is a region other than the corners.

3. The liquid crystal display device according to claim 1,
wherein the backlight further includes a light guide plate,
the light source is disposed to face a side surface of the light guide plate, and
the light guide plate has a lower light extraction efficiency in its region corresponding to the first light-emitting region than in its region corresponding to the second light-emitting region.

4. The liquid crystal display device according to claim 1,
wherein the backlight further includes a light diffuser plate disposed closer to the liquid crystal panel than the light source is, and
the light diffuser plate has a lower light extraction efficiency in its region corresponding to the first light-emitting region than in its region corresponding to the second light-emitting region.

5. The liquid crystal display device according to claim 1,
wherein the backlight further includes a light transmittance adjustment film disposed closer to the liquid crystal panel than the light source is, and
the light transmittance adjustment film has a lower light transmittance in its region corresponding to the first light-emitting region than in its region corresponding to the second light-emitting region.

6. The liquid crystal display device according to claim 1,
wherein the light-emitting region includes blocks including a block in the first light-emitting region and a block in the second light-emitting region, and
a luminance of the backlight is adjustable for each of the blocks.
